(19) United States
(12) Patent Application Publication
(10) Pub. No.: US 2026/0129007 A1
(43) Pub. Date: May 7, 2026

(54) Switch, Switch Cabinet, and Data Switching Method

(71) Applicant: HUAWEI TECHNOLOGIES CO., LTD., Shenzhen (CN)

(72) Inventors: Xiaoyong Ming, Dongguan (CN); Xiaopeng Peng, Shenzhen (CN); Jun Li, Nanjing (CN); Guoding Liu, Dongguan (CN)

(73) Assignee: HUAWEI TECHNOLOGIES CO., LTD., Shenzhen (CN)

(21) Appl. No.: 19/437,517

(22) Filed: Dec. 31, 2025

Related U.S. Application Data
(63) Continuation of application No. PCT/CN2024/101703, filed on Jun. 26, 2024.

(30) Foreign Application Priority Data
Jul. 4, 2023 (CN) 202310814632.0

(51) Int. Cl. H04L 49/111; H04L 49/00

(52) U.S. Cl. CPC H04L 49/111; H04L 49/3018

(57) ABSTRACT

A switch includes at least two interface modules, a switching module, and an ingress processing module. The at least two interface modules include a first interface and a second interface. The first interface is configured to send and receive a first packet that is based on a first protocol, and the second interface is configured to send and receive a second packet that is based on a second protocol. The interface module is configured to obtain a to-be-forwarded packet, where the to-be-forwarded packet is one of the first packet and the second packet. The ingress processing module is configured to receive the to-be-forwarded packet from the interface module, and obtain first indication information corresponding to the to-be-forwarded packet, where the first indication information indicates a destination interface corresponding to the to-be-forwarded packet.

### CROSS-REFERENCE TO RELATED APPLICATIONS

This is a continuation of International Patent Application No. PCT/CN2024/101703 filed on Jun. 26, 2024, which claims priority to Chinese Patent Application No. 202310814632.0 filed on Jul. 4, 2023. The disclosures of the aforementioned applications are hereby incorporated by reference in their entireties.

### TECHNICAL FIELD

Embodiments of this disclosure relate to the field of electronic information, and in particular, to a switch, a switch cabinet, and a data switching method.

### BACKGROUND

With popularization of cloud computing and high-performance computing, more applications and data are migrated to data centers. Services and an amount of data processed by the data centers grow explosively, and requirements on computing power of the data centers are increasingly high. However, due to limitations of Moore's Law and slowdown in processor performance growth, a domain specific architecture (DSA) gradually becomes a trend, and more heterogeneous processors/accelerators are introduced into the data centers. In addition, based on a memory wall, both a capacity and a bandwidth of a memory of a single server become bottlenecks for performance of a high-performance processor. Therefore, a disaggregated data center is promoted. In an example, key resources such as a heterogeneous processor, an accelerator, and a memory are pooled, to meet continuously growing computing power and memory requirements. In this architecture, a communication delay and a transmission bandwidth between different types of resources limit performance of the high-performance processor.

### SUMMARY

This disclosure provides a switch, a switch cabinet, and a data switching method, to optimize networking in the switch cabinet and improve resource utilization in the cabinet.

According to a first aspect, this disclosure provides a switch, for example including at least two interface modules, a switching module, and an ingress processing module. The at least two interface modules include a first interface and a second interface. The first interface is configured to send and receive a first packet that is based on a first protocol, and the second interface is configured to send and receive a second packet that is based on a second protocol. The interface module is configured to obtain a to-be-forwarded packet, where the to-be-forwarded packet is one of the first packet and the second packet. The ingress processing module is configured to receive the to-be-forwarded packet from the interface module, and obtain first indication information corresponding to the to-be-forwarded packet, where the first indication information indicates a destination interface corresponding to the to-be-forwarded packet. The switching module is configured to receive the to-be-forwarded packet and the first indication information from the ingress processing module, and send the to-be-forwarded packet to the destination interface based on the first indication information.

A plurality of interfaces supporting different protocols, the ingress processing module supporting switching of at least one protocol, and a switching module supporting different protocols are configured for the switch, to receive, process, switch, and forward packets of a plurality of different protocols, so as to reduce costs and power consumption of a switch device. In addition, local resources (such as a memory, a hard disk, and an accelerator) that are originally configured in a server and that overflow may be configured outside a cabinet as pooled resources, and data transmission is implemented through a bus and a top-of-rack (ToR) switch that supports switching of a plurality of protocols. This further reduces system costs and power consumption, and also removes a limitation that the local resources are used by only the server, thereby improving resource utilization, implementing flexible resource configuration, and implementing a plurality of new services.

In an implementation, the ToR switch further includes an egress processing module, configured to receive the to-be-forwarded packet and the first indication information from the switching module, and send the to-be-forwarded packet to the interface module. The interface module includes the destination interface.

In an implementation, the ingress processing module in the switch is configured to connect to at least two interfaces, where the at least two interfaces include the first interface and the second interface. The ingress processing module is enabled to work in different protocols, to reduce a quantity of ingress processing modules that are necessary in the switch, so as to reduce system costs and power consumption.

In an implementation, the egress processing module in the switch is configured to connect to at least two interfaces, where the at least two interfaces include the first interface and the second interface. The egress processing module is enabled to work in different protocols, to reduce a quantity of egress processing modules that are necessary in the switch, so as to reduce system costs and power consumption.

According to a second aspect of this disclosure, a switch is provided, and includes at least two interface modules, a first switching module, an ingress processing module, and a multi-protocol conversion module. The at least two interface modules include a first interface and a second interface. The first interface is configured to send and receive a first packet that is based on a first protocol, and the second interface is configured to send and receive a second packet that is based on a second protocol. The interface module is configured to obtain a to-be-forwarded packet, where the to-be-forwarded packet is one of the first packet and the second packet. The multi-protocol conversion module is configured to receive the to-be-forwarded packet, and convert the to-be-forwarded packet into a third packet based on a configuration, where the third packet and the to-be-forwarded packet are packets based on different protocols. The first switching module is configured to receive the third packet and corresponding indication information, and send the received third packet to the destination interface based on the indication information. The indication information is generated by the ingress processing module and indicates the destination interface corresponding to the received packet, and the ingress processing module is configured to obtain the indication information corresponding to the received packet.

A plurality of interfaces supporting different protocols, an ingress processing module supporting switching of at least one protocol, a switching module supporting one protocol, and a multi-protocol conversion module used for protocol conversion are configured for the switch, to implement conversion between intra-cabinet protocols and inter-cabinet different protocols, and cancel deployment of a multi-protocol conversion module on each server, so as to reduce system costs and power consumption. In addition, a new networking manner in the cabinet can be updated through the switch, so that the server can access a plurality of pooled resources in the cabinet by using only one bus protocol, including but not limited to a memory, a hard disk, and an accelerator. This further reduces system interconnection costs and power consumption.

In an implementation, the interface module in the switch is connected to the ingress processing module, and the ingress processing module is connected to the multi-protocol conversion module.

In an implementation, the interface module in the switch is connected to the multi-protocol conversion module, and the multi-protocol conversion module is connected to the ingress processing module.

In an implementation, the switch further includes a second switching module. The interface module is connected to the ingress processing module, the ingress processing module is connected to the second switching module, and the second switching module is connected to the multi-protocol conversion module.

In an implementation, the switch further includes an egress processing module, configured to receive the to-be-forwarded packet and the first indication information from the switching module, and send the to-be-forwarded packet to the interface module. The interface module includes the destination interface.

According to a third aspect of this disclosure, a switch cabinet is provided, and includes the switch according to the first aspect, at least one server electrically connected to the switch, and at least one resource pool electrically connected to the switch. The resource pool includes at least one of a plurality of memory resources, a plurality of hard disk resources, and a plurality of accelerator resources.

In an implementation, the switch cabinet further includes a multi-protocol conversion apparatus, and the multi-protocol conversion apparatus is electrically connected to the switch.

According to a fourth aspect of this disclosure, a switch cabinet is provided, and includes the switch according to the second aspect, at least one server electrically connected to the switch, and at least one resource pool electrically connected to the switch. The resource pool includes at least one of a plurality of memory resources, a plurality of hard disk resources, and a plurality of accelerator resources.

### BRIEF DESCRIPTION OF DRAWINGS

FIG. 1 is a diagram of an architecture of a cabinet according to an embodiment of this disclosure;

FIG. 2 is a diagram of an architecture of a cabinet in which some resources are shared according to an embodiment of this disclosure;

FIG. 3 is a diagram of an architecture of a cabinet according to an embodiment of this disclosure;

FIG. 4 is a diagram of an architecture of a switch according to an embodiment of this disclosure;

FIG. 5 is a flowchart of packet processing by a switch according to an embodiment of this disclosure;

FIG. 6 is a diagram of an architecture of another switch according to an embodiment of this disclosure;

FIG. 7 is a diagram of an architecture of another switch according to an embodiment of this disclosure; and

FIG. 8 is a diagram of an architecture of another switch according to an embodiment of this disclosure.

### DESCRIPTION OF EMBODIMENTS

To make the objectives, technical solutions, and advantages of this disclosure clearer, the following describes the technical solutions in this disclosure with reference to the accompanying drawings in this disclosure. It is clear that the described embodiments are a part rather than all of embodiments of this disclosure. All other embodiments obtained by a person of ordinary skill in the art based on embodiments of this disclosure without creative efforts shall fall within the protection scope of this disclosure.

In the specification, embodiments, claims, and accompanying drawings of this disclosure, the terms “first”, “second”, and the like are merely intended for distinguishing and description, and shall not be understood as indicating or implying relative importance, or indicating or implying a sequence. Moreover, the terms “include”, “have”, and any other variant thereof are intended to cover a non-exclusive inclusion, for example, including a series of steps or units. For example, a method, system, product, or device is not necessarily limited to those steps or units expressly listed, but may include other steps or units not expressly listed or inherent to such a process, method, product, or device.

It should be understood that in this disclosure, “at least one piece (item)” refers to one or more and “a plurality of” refers to two or more. The term “and/or” is used to describe an association relationship between associated objects, and indicates that three relationships may exist. For example, “A and/or B” may indicate the following three cases: Only A exists, only B exists, and both A and B exist, where A and B may be singular or plural. The character “/” generally indicates an “or” relationship between the associated objects. The expression “at least one of the following items (pieces)” or a similar expression means any combination of these items, including a single item (piece) or any combination of a plurality of items (pieces). For example, at least one of a, b, or c may indicate a, b, c, a and b, a and c, b and c, or a, b, and c, where a, b, and c may be singular or plural.

Rapid development of technologies such as cloud computing, big data, and artificial intelligence poses higher requirements on data center networks that carry data traffic. Requirements of services on the data center networks include high throughput, high reliability, low latency, and adaptation to server virtualization. To meet network requirements of services, more enterprises choose to build their own data centers or rent public clouds to carry increasing service traffic. A modern data center is equipped with a physical rack in which at least one physical server is mounted. Each physical server is deployed with at least a central processing unit (CPU), and is further deployed with localized resources, including a memory, a solid-state drive (SSD), an accelerator (for example, including a graphics processing unit (GPU), a network interface card, and the like.

Because a scale of a current data center is increased, a plurality of physical racks may be placed in a cabinet, and physical servers in the plurality of physical racks may implement connection and communication through switches. Based on deployment locations of the switches in the cabinet (which may also be understood as different access manners of a server), a physical architecture of the switches is generally classified into two types such as ToR and end-of-row (EoR)/middle-of-row (MoR).

ToR means that one or two switches are deployed in each server cabinet, and a server is directly connected to a switch in the cabinet to implement interconnection between the server and the switch in the cabinet. Generally, deploying switches on the top of the cabinet facilitates cabling. In an example, this architecture is most widely used.

In contrast, the EoR architecture provides a unified network access point at the end of each row of cabinets. The MoR architecture is an improvement of the EoR architecture, and also provides a unified network access cabinet for a server. However, the MoR architecture requires placing the network cabinet in the middle of an entire row of cabinets. This shortens a distance between a server cabinet and the network cabinet to some extent, and simplifies cable management and maintenance.

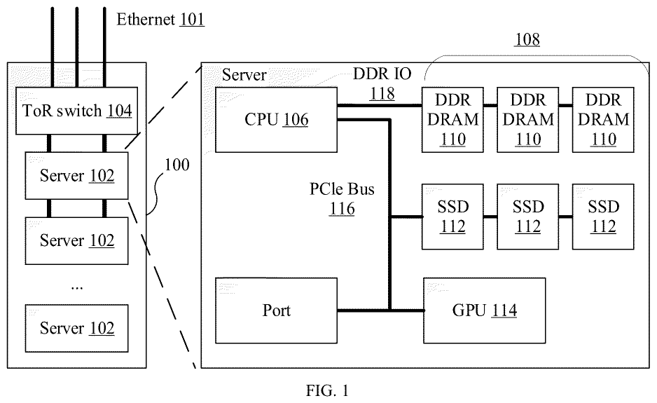

FIG. 1 provides an architecture of a cabinet 100. The cabinet 100 includes a plurality of servers 102 and at least one ToR switch 104 inside the cabinet 100. A CPU 106 and a local resource 108 deployed on each server are used by only the server 102 and cannot be shared. The plurality of servers 102 may be connected to the ToR switch 104 according to an Ethernet protocol. Further, the ToR switch 104 may be connected to a spine switch (not shown) through an Ethernet interface, to establish a data center network and meet a larger scale requirement.

Each server 102 in FIG. 1 is generally configured with at least one CPU 106, a memory (for example, a double data rate dynamic random-access memory (DDR DRAM) 110, a solid-state drive (SSD) 112, and an accelerator GPU 114. External data may be transmitted from the switch 104 to the server 102 through the Ethernet interface 101, and further transmitted to different localized resources 108 through an internal bus and different interfaces of the server for processing or storage. For example, the Ethernet interface 101 may be connected to the CPU 106, the GPU 114, and the SSD 112 through a Peripheral Component Interconnect Express (PCIe) bus 116. When performing data processing, the CPU 106 stores data in the memory 108 through a double data rate (DDR) input/output (I/O) interface 118.

Because a ratio of a computing capability to a localized resource in a physical server is fixed during delivery or configuration of the physical server, resources may be configured based on a maximum capacity of a related service preset during delivery or configuration. In an example, not only a resource waste may occur, but also when a new service proposes a larger capacity requirement, a single server cannot provide sufficient resources to meet the requirement of the new service. New services include a REmote Dictionary Server (Redis), a database, artificial intelligence (AI) computing, and the like. These new services usually have higher requirements on a memory capacity and a hard disk capacity.

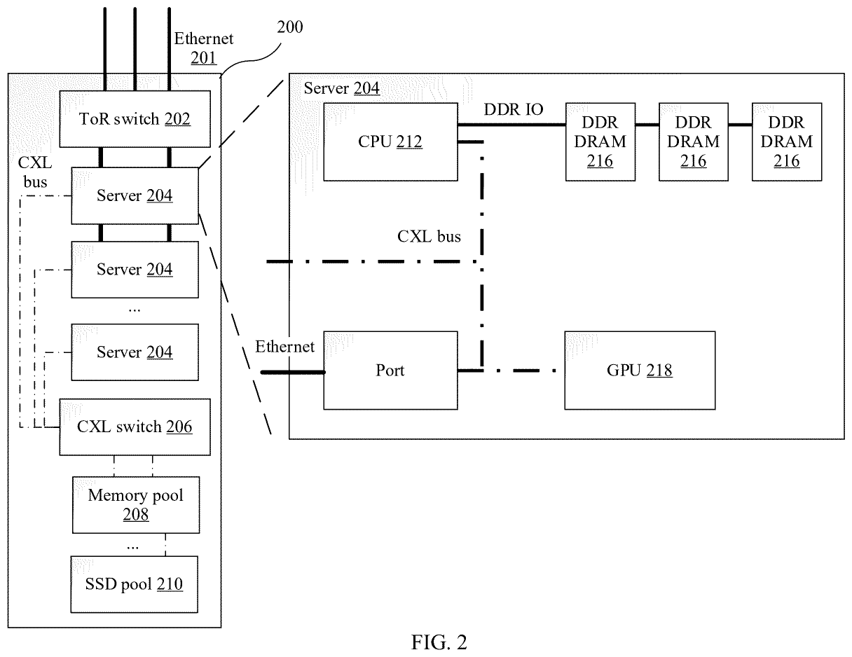

Based on the foregoing service requirement change, the problem may be resolved by adding an interface to the server and implementing resource pooling in the cabinet. FIG. 2 shows an architecture of a cabinet 200 in which some resources are shared. The cabinet 200 includes a plurality of servers 204, at least one ToR switch 202, at least one resource switch 206, a memory pool 208, and an SSD pool 210 inside. The memory pool 208 and the SSD pool 210 in the cabinet 200 are shared by all the servers 204 in the cabinet 200.

The ToR switch 202 implements communication between the plurality of servers, and may be connected to a spine switch through an Ethernet interface 201 to establish a data center network and meet a larger scale requirement.

The resource switch 206 implements data exchange between the server204 and the memory pool 208 or the SSD pool 210 by supporting communication protocols such as Compute eXpress Link (CXL) or unified buffer (UB).

Each server 204 is configured with an Ethernet interface to implement communication with the ToR switch 202, and is further configured with at least one interface to implement data transmission with the resource switch 206 according to the communication protocols such as CXL or UB. In addition, a CPU 212 and some local resources such as a GPU 218, a network interface card, and a local dynamic random-access memory (DRAM) 216 are deployed in the server 204. The local DRAM 216 and the memory pool 208 in the cabinet 200 may form a memory structure with different tiers. These local resources are used by only the server 204 and cannot be shared.

With development of an internet, data explosion occurs, and virtualization technologies develop. Cloud computing and high-performance computing become more popular. As a result, greater challenges are posed to computing power of data centers, and further optimization is required for a layout and resources in an existing cabinet. In an example, a new switch architecture is urgently needed to improve resource utilization in the cabinet, optimize an operation and switching rate, and meet an evolving service requirement.

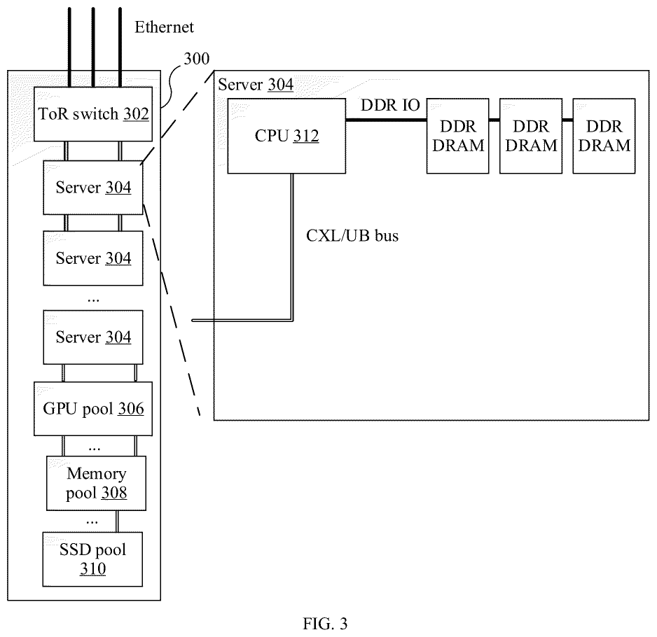

FIG. 3 provides an architecture of a cabinet 300. A plurality of servers 304, at least one switch 302, and a plurality of resource pools are disposed in the cabinet 300. The plurality of resource pools includes but are not limited to a memory pool 308 (for example, a DDR DRAM pool), a hard disk pool 310 (for example, an SSD pool), an accelerator pool 306 (for example, a GPU pool), and a network interface card. The switch 302 may be a ToR switch, an EoR switch, or an MoR switch, and is used for intra-cabinet communication and data communication between a cabinet and the outside of the cabinet. The following uses the ToR switch as an example.

The ToR switch is configured with an internal switching interface, and the internal switching interface supports an internal data interconnection protocol, for example, including a CXL protocol and a UB protocol. Through the internal switching interface, the ToR switch interconnects the servers 304 in the cabinet 300 with various resource pools, so that the memory pool 308, the hard disk pool 310, the accelerator pool 306, the network interface card, and the like are shared by all the servers 304 in the cabinet 300.

A relationship between a service requirement and an upper limit of a configured resource capacity of a server at delivery or configuration is decoupled by pooling and centralizing local resource pools originally in the server to resource pools in a rack, and enabling the TOR switch to connect the server to the resource pools, to improve resource utilization and meet flexible configuration of computing resources for various services. In addition, due to transfer of the local resource in the server, a type of CPU bus interconnection in the server can be reduced, to reduce system costs and power consumption.

Further, the ToR switch is further configured with a standard Ethernet interface, and may be connected to a spine switch outside the cabinet through the standard Ethernet interface, to establish a data center network and meet a larger scale requirement.

The server 304 in the cabinet 300 is also configured with an internal switching interface, and the internal switching interface supports an internal data interconnection protocol, for example, including a CXL protocol and a UB protocol. In addition, the server 304 further includes a CPU 312, and is connected to the ToR switch through the internal switching interface.

Optionally, a memory resource is further configured inside the server 304, and a two-layer memory architecture is implemented by using a local memory resource and a shared memory pool in the rack, to balance performance and a capacity, so that a service that requires a large memory can be resolved at low costs.

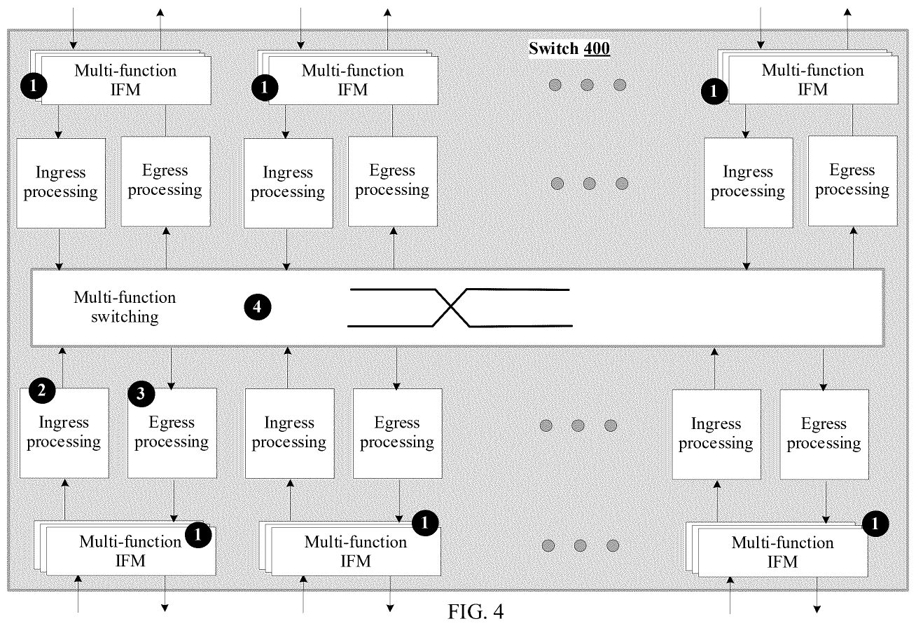

To implement the foregoing rack structure, FIG. 4 provides an architecture of a ToR switch 400, which includes a multi-function interface module 1, an ingress processing unit 2, an egress processing unit 3, and a multi-protocol switching unit 4. The multi-function interface module 1is connected to at least one ingress processing unit 2and one downlink packet processing unit, and the multi-protocol switching unit 4is connected to all ingress processing units 2 and egress processing units 3.

The multi-function interface module 1 is also referred to as a multi-function integrated facility management (MIFM) module. The multi-function interface module 1 includes a media access control (MAC) layer, a physical coding sublayer (PCS), and a physical layer (PHY), and supports at least one intra-rack data interconnection protocol, including but not limited to a standard Ethernet protocol, a standard CXL protocol, a standard UB protocol, or another bus protocol. The multi-function interface module 1 may support a plurality of data interconnection protocols. After configuration is completed, the multi-function interface module 1works in one of the plurality of data interconnection protocols. In other words, one multi-function interface module 1 receives and/or sends packets that are based on a same protocol at the same time. For example, a first MIFM module 1may be configured to work in the standard Ethernet protocol, and may be connected to a spine switch outside the cabinet. A second MIFM module may be configured to work in the standard CXL protocol, and may be connected to the server in the cabinet. Data switching in the memory pool is based on the standard CXL protocol.

Each multi-function interface module 1is connected to one ingress processing module 2 and one egress processing module 3.

An ingress processing (IP) module 2 is connected to at least one multi-function interface module 1, is used for processing, including but is not limited to processing such as data aggregation, parsing, table lookup, route selection, editing and forwarding, on an uplink packet from the multi-function interface module 1, and supports at least one intra-rack data forwarding protocol, including but not limited to the standard Ethernet protocol (including a standard Ethernet layer 2/layer 3 forwarding protocol and standard Ethernet tunnel processing), the standard CXL protocol, the standard UB protocol, or another bus protocol. Preferably, the ingress processing module 2 may support a plurality of data forwarding protocols, and may support forwarding of packets a plurality of protocols at the same time. When the IP module 2 is connected to two or more MIFM modules 1, the two or more MIFM modules 1may be configured to work in different data interconnection protocols. In an example, the IP module 2 may receive and/or send packets of a plurality of protocols at the same time.

An egress processing (EP) module 3 is connected to at least one multi-function interface module 1, is used for processing, including but is not limited to processing such as data parsing, table lookup, encapsulation, editing, and distribution, on a downlink packet from the multifunction interface module 1, and supports at least one intra-rack data forwarding protocol, including but not limited to the standard Ethernet protocol (including the standard Ethernet layer 2/layer 3 forwarding protocol and standard Ethernet tunnel processing), the standard CXL protocol, the standard UB protocol, or another bus protocol. Similar to the ingress processing module, the egress processing module 3 may also support a plurality of data forwarding protocols, that is, support forwarding of packets a plurality of protocols at the same time.

The multi-protocol switching (MFS) module 4 is connected to all the ingress processing modules2 and egress processing modules 3, and performs switching processing, including but not limited to operations such as data buffering, switching, enqueue, scheduling, and quality of service (QoS) management, on the packets the plurality of protocols from the ingress processing module. The plurality of supported protocols includes but are not limited to a standard Ethernet protocol (including a standard Ethernet layer 2/layer 3 switching protocol and standard Ethernet tunnel switching), a standard CXL protocol, a standard UB protocol, or another bus protocol. Similar to the ingress processing module 2, the MFS module 4 also supports switching of packets a plurality of protocols at the same time.

The ToR switch 400is configured with a plurality of interfaces that support different protocols (for example, a first interface that is in the MIFM module 1 and that supports the standard Ethernet protocol and a second interface in the MIFM module 1 and that supports the standard CXL protocol), an ingress processing module 3, an egress processing module 2, and a multi-protocol switching module 4 that support switching of a plurality of types of protocols. In an example, the ToR switch 400 can receive, process, switch, and forward packets of a plurality of different protocols, without requiring at least two switches that separately support communication of different protocols. This reduces costs and power consumption of a switch device. The server in the cabinet can not only receive and send conventional packet data based on the standard Ethernet protocol, but also store, in a pooled resource in the cabinet, packet data based on the standard CXL protocol or the standard UB protocol. In addition, local resources (such as a memory, a hard disk, and an accelerator) that are originally configured in a server and that overflow may be configured outside a cabinet as pooled resources, and data transmission is implemented through a bus and a ToR switch 400 that supports switching of a plurality of protocols. This further reduces system costs and power consumption, and also removes a limitation that the local resources are used by only the server, thereby improving resource utilization, implementing flexible resource configuration, and implementing a plurality of new services.

Optionally, the ToR switch 400may be further connected to a multi-protocol converter, for example, a network interface card, configured to implement fast protocol conversion of a packet, for example, convert a packet based on the standard Ethernet protocol into a packet based on the standard CXL protocol, to improve packet switching efficiency and expand a storage acceleration service.

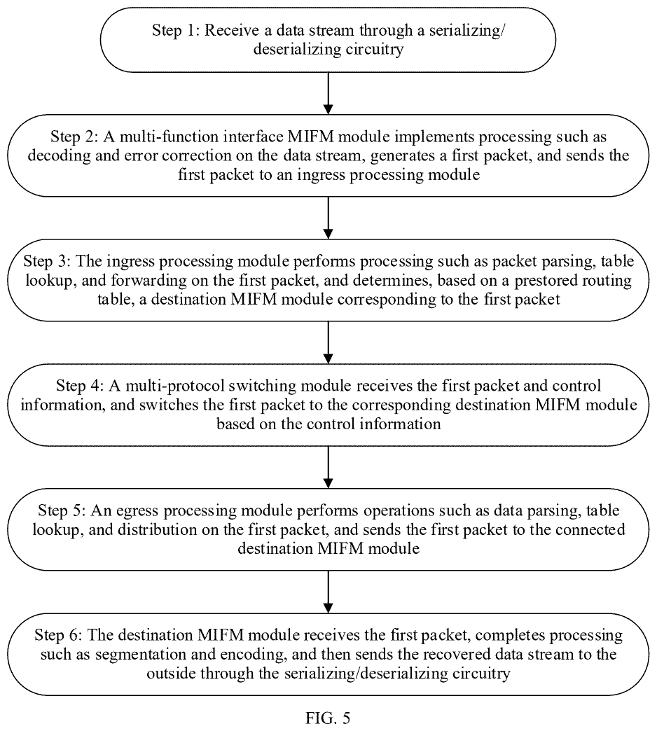

FIG. 5 provides a packet processing procedure of the ToR switch in FIG. 4.

Step 1: Receive a data stream through a serializing/deserializing circuitry (SerDes).

The data stream is a data stream based on a first protocol, and the first protocol is one of a plurality of protocols supported by the multi-function interface module and the multi-protocol switching module in the TOR switch. The ToR switch is connected to the server or a local pooled resource, including but is not limited to a memory pool, a storage pool, an accelerator pool, and the like, in the cabinet through the SerDes.

For example, the ToR switch receives a data stream from the server in the cabinet, and needs to store the data in an SSD pool. The data stream may be a data stream based on a standard CXL protocol.

Step 2: The multi-function interface module receives the data stream, generates a first packet, and sends the first packet to the ingress processing module.

In an example, operations performed by the MIFM module on the data stream include decoding, error correction, framing, error check, retransmission, and the like. For example, when the MIFM module is configured to work in a standard CXL mode, the first packet is a standard CXL packet.

Step 3: The ingress processing module receives the first packet, and forwards the first packet and control information to the multi-protocol switching module.

In an example, the IP module performs operations including packet parsing, table lookup, forwarding, editing, and the like on the first packet, and determines, based on a prestored routing table, a destination MIFM module corresponding to the first packet, and information related to the destination MIFM module is carried in the control information.

For example, when the first packet is a standard CXL packet, the IP module works in a standard CXL mode, to process the first packet.

In a possible implementation, the IP module is connected to a plurality of MIFM modules, and switches a working mode based on a received packet, to process packets of different protocols.

Step 4: The multi-protocol switching module receives the first packet and the control information, and switches the first packet to the corresponding destination MIFM module based on the control information.

In a possible implementation, the multi-protocol switching module stores the first packet in a built-in cache, stores the control information in a corresponding queue based on the destination MIFM module that is of the first packet and that is indicated by the control information, then schedules the control information from the queue, reads the first packet from the cache, and switches the first packet and the control information to the corresponding destination MIFM module together.

For example, when the first packet is a standard CXL packet, the MFS module works in a standard CXL mode, to forward the first packet.

Step 5: The egress processing module receives the first packet and the control information from the multi-protocol switching module, and sends the first packet to the connected destination MIFM module based on the control information.

In an example, operations performed by the EP module on the first packet include data parsing, table lookup, encapsulation, editing, distribution, and the like.

For example, when the first packet is a standard CXL packet, the EP module works in a standard CXL mode, to process the first packet.

In a possible implementation, the EP module switches a working mode based on received packets and control information, to process packets of different protocols, and is further connected to a plurality of MIFM modules, and forwards a packet to a corresponding destination MIFM module based on control information from the MFS module.

Step 6: The destination MIFM module receives the first packet and the control information, and sends the data stream to the outside through the SerDes.

In an example, processing performed by the MIFM module on the first packet includes processing such as segmentation and encoding.

For example, the destination MIFM module works in a standard CXL mode, and is connected to an SSD pool. The ToR switch completes data switching between the server and the SSD pool.

According to the foregoing processing procedure, the ToR switch completes processing of a data stream from a server or a resource pool in the cabinet, and forwards the data stream to another server or another resource pool in the cabinet.

Further, the ToR switch may be further connected to a network interface card module, and the network interface card module implements multi-protocol conversion on a packet. For example, the network interface card module is connected to at least two MIFM modules of the ToR switch, including a first MIFM module that works in a standard Ethernet mode and a second MIFM module that works in a standard CXL mode. When the ToR switch switches data with a spine switch outside the cabinet by using a standard Ethernet packet, and the ToR switch switches data with the server in the cabinet by using a standard CXL packet, the network interface card module may convert a standard Ethernet packet from the spine switch outside the cabinet into a standard CXL packet, and forward the standard CXL packet to the server.

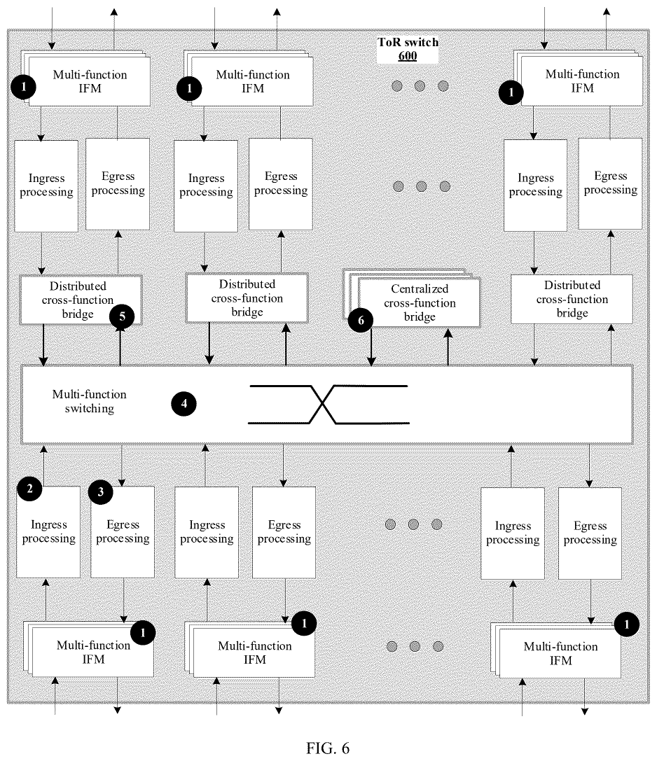

FIG. 6 provides an architecture of another ToR switch 600. Similar to the switch architecture in FIG. 4, the switch architecture in FIG. 6 also includes a multi-function interface module 1, an ingress processing module 2, an egress processing module 3, and a multi-protocol switching module 4. In addition, a multi-protocol conversion module 5 is added to implement processing of the ToR switch 600 on packets based on a plurality of protocols. In the switch architecture in FIG. 6, the multi-function interface module 1, the ingress processing module 2, and the egress processing module 3 support only one of the plurality of protocols, and this is not changed after configuration is completed. The multi-protocol switching unit 4 supports switching of the plurality of protocols. The plurality of protocols includes but are not limited to a standard Ethernet protocol, a standard CXL protocol, a standard UB protocol, or another bus protocol.

The newly added multi-protocol conversion (CFB) module 5 is configured to convert a packet that is based on a first protocol into a packet that is based on a second protocol, to implement communication between different bus data transmission through only one ToR switch 600, for example, including processing such as data buffering, protocol parsing, protocol conversion, out-of-order rearrangement, segmentation and reassembly, data check, and data retransmission.

The multi-protocol conversion module 5 is integrated into the switch to implement conversion between intra-cabinet protocols and inter-cabinet different protocols, and a multi-protocol conversion module 5 does not need to be deployed on each server. This reduces system costs and power consumption. In addition, a new networking manner in the cabinet can be updated through the switch, so that the server can access a plurality of pooled resources in the cabinet by using only one bus protocol, including but not limited to a memory, a hard disk, and an accelerator. This further reduces system interconnection costs and power consumption.

In an implementation, the multi-protocol conversion module 5 is connected to the ingress processing module 2 and/or the egress processing module 3. The multi-protocol conversion module 5 may be referred to as a distributed multi-protocol conversion module (DCFB). Optionally, each distributed multi-protocol conversion module 5 is connected to one ingress processing module 2 and one egress processing module 3. That is, there are N groups of ingress processing modules 2 and egress processing modules 3, and correspondingly, N distributed multi-protocol conversion modules 5 need to be configured. Optionally, at least one distributed multi-protocol conversion module 5 may be configured for the N groups of ingress processing modules 2 and egress processing modules 3 based on a preconfiguration. The DCFB module 5 supports conversion of packets of a plurality of protocols at the same time.

Optionally, each DCFB module 5 is connected in series between an MIFM module 1 and a group of an IP module 2 and an EP module 3. In a possible implementation, the MIFM module 1 connected to the DCFB module 5 works in a first protocol, and the group of the IP module 2 and the EP module 3 connected to the DCFB module 5 works in a second protocol. For a packet that is received from the MIFM module 1 and that is based on the first protocol, the DCFB module 5 first completes protocol conversion, and then sends a packet based on the second protocol to the IP module 2 for forwarding-related processing. Correspondingly, the DCFB module 5 may further receive a packet from the EP module 3, and send a packet to the MIFM module 1 after completing protocol conversion.

Optionally, each DCFB module 5 is connected in series between a group of an IP module 2 and an EP module 3 and an MFS module 4. A packet sent by the IP module 2 to the MFS module 4 is sent to the MFS module 4 after protocol conversion by the DCFB module 5. A packet sent by the MFS module 4 to the EP module 3 is sent to the EP module 3 after protocol conversion by the DCFB module 5.

Optionally, each MIFM module 1 is connected to a group of an IP module 2 and an EP module 3, and the IP module 2 and the EP module 3 are connected to a corresponding DCFB module 5.

For example, the DCFB module 5 may include the following several types such as a network interface card (NIC), a smart network interface card (Smart NIC), a data processing unit (DPU), or the like. When the IP module 2 or the EP module 3 is connected to a plurality of servers, preferably, the DCFB module 5 supports a multi-host (Multi-Host) mode, and can be shared by the plurality of servers.

In an implementation, the multi-protocol conversion module is connected to only the MFS module 4, and the multi-protocol conversion module may be referred to as a centralized multi-protocol conversion module (CCFB) 6.

After a packet is sent to the MFS module 4 through the IP module 2, the MFS module 4 sends the packet on which protocol conversion needs to be performed to the CCFB module 6. After completing protocol conversion of the packet, the CCFB module 6 sends the packet back to the MFS module 4. Finally, the MFS module 4 switches the packet to a destination MIFM module 1.

For example, the CCFB module 6 may include the following several types: a macro NIC, a macro Smart NIC, and a macro DPU. When the IP module 2 or the EP module 3 is connected to a plurality of servers, preferably, the CCFB module 6 supports a multi-host mode, and can be shared by the plurality of servers.

Optionally, both the DCFB module 5 and the CCFB module 6 may be configured to implement conversion between multi-protocol packets. In an example, packets of different interface modules may be configured to be processed by the DCFB module 5 or the CCFB module 6 based on different service requirements. For example, the DCFB module 5 is configured to perform packet conversion of a simple service with a large bandwidth, and the CCFB module 6 is configured to perform packet conversion of a complex service.

A ToR switch configured with a DCFB module 5 is used as an example. The DCFB module 5 is configured to be connected between an MFS module 4 and a group of an IP module 2 and an EP module 3. In this case, a packet processing procedure of the ToR switch is as follows.

Step 1: Receive a data stream through a SerDes.

Step 2: An MIFM module 1 implements processing such as decoding, error correction, framing, error check, and retransmission on the data stream, generates a first packet, and sends the first packet.

Step 301: The IP module 2 performs processing such as packet parsing, table lookup, forwarding, and editing on the received first packet, determines, based on a prestored routing table, a destination MIFM module 1 corresponding to the received packet, and sends the first packet and control information.

Step 302: The DCFB module 5 determines, based on a preconfiguration, that protocol conversion needs to be performed on the first packet, converts the first packet based on a first protocol into a second packet based on a second protocol, and sends the second packet to a multi-protocol switching module 4.

Step 4: The MFS module 4 receives the second packet and the control information, and switches the packet to a corresponding destination MIFM module 1 based on the control information.

Step 5: An egress processing module receives the second packet, performs operations such as data parsing, table lookup, encapsulation, editing, and distribution, and sends the first packet to the connected destination MIFM module 1.

In a possible implementation, the egress processing module 3 is connected to a plurality of MIFM modules 1, and the egress processing module 3 forwards the first packet to the destination MIFM module 1 based on control information sent by the multi-protocol switching module 4.

Step 6: The destination MIFM module 1 receives the packet, completes processing such as segmentation and encoding, and then sends the recovered data stream to the outside through the SerDes.

Optionally, the DCFB module 5 may alternatively be configured between the MIFM module 1 and a group of an IP module 2 and an EP module 3.

Optionally, the multi-protocol conversion module may alternatively be a CCFB module 6, and the CCFB module 6 is connected to the MFS module 4. After receiving a packet, the MFS module 4 first sends all received packets to the CCFB module 6, or sends some packets to the CCFB module 6 based on a configuration. The CCFB module 6 receives the packet from the MFS module 4, and sends a converted packet back to the MFS module 4after completing protocol conversion.

In an implementation, the IP module 2 and the EP module 3 may be configured to be in a single-protocol mode, and a single protocol supported by the IP module 2 and a single protocol supported by the EP module 3 include but are not limited to one of a standard Ethernet protocol, a standard CXL protocol, a standard UB protocol, or another bus protocol. A protocol mode supported by the IP module 2 and a protocol mode supported by the EP module 3 should be configured based on a location of the DCFB module 5, the MIFM module 1, and a type of an external resource connected to the MIFM module 1.

For example, the MIFM module 1is connected to an SSD pool that supports the standard CXL protocol. When the DCFB module 5 is configured between the MIFM module 1 and the IP module 2 or the EP module 3, the IP module 2 or the EP module 3 may be configured to support the standard Ethernet protocol, and the DCFB module 5 converts a packet from a packet based on the standard Ethernet protocol to a packet based on the standard CXL protocol, to implement packet forwarding.

For example, the MIFM module 1 is connected to an SSD pool that supports the standard CXL protocol. When the DCFB module 5 is configured between the MFS module 4 and the IP module 2 or the EP module 3, the IP module 2 or the EP module 3 may be configured to support the standard CXL protocol, to prevent a packet forwarding failure caused by a mismatch between a protocol configured for the IP module 2 or the EP module 3 and a protocol for the connected MIFM module 1.

According to the foregoing processing procedure, the ToR switch 600 completes processing of a data stream from a server or a resource pool in the cabinet, and forwards the data stream to another server or another resource pool in the cabinet.

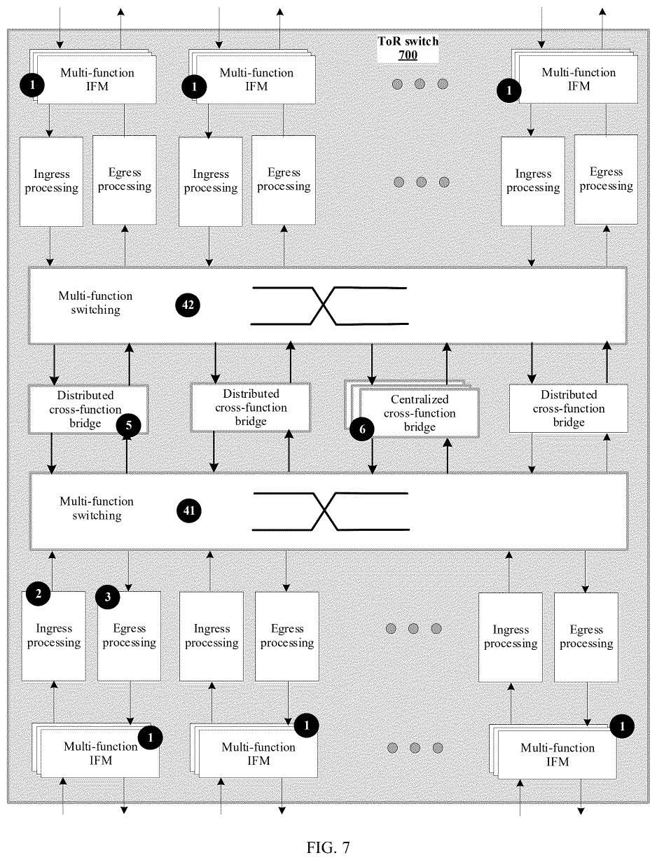

FIG. 7 provides an architecture of another ToR switch 700. In the switch architecture, not only the MIFM module 1, the IP module 2, the EP module 3, the MFS module 41, and the multi-protocol conversion module 5/6 exist, but also another MFS module 42 exists. In the architecture, the multi-protocol conversion module is disposed between the two MFS modules 41 and 42, so that protocol conversion is implemented on a packet between two times of switching performed by the two MFS modules 5/6, and the ToR switch 700 can support switching of a multi-protocol packet. In this architecture, the modules (except the multi-protocol conversion module) can support only one type of protocol switching. This reduces requirements on components of the modules and reduces costs.

In an implementation, the multi-protocol conversion module may be at least one DCFB module 5, and the DCFB module 5 is disposed between the two MFS modules 41 and 42 in parallel. The DCFB module 5 receives a packet from an MFS module 41 and 42 on either side, and sends the packet to an MFS module 41 and 42 on the other side after completing protocol conversion. A quantity of disposed DCFB modules 5 may be determined based on a total service quantity or a total interface quantity.

In another implementation, the multi-protocol conversion module may be at least one CCFB module 6. When there is a plurality of CCFB modules 6, the CCFB modules 6 are disposed between the two MFS modules in parallel. The CCFB module 6 receives a packet from an MFS module 41 and 42 on any side, and sends the packet to another MFS module 41 and 42 after completing protocol conversion. A quantity of disposed CCFB modules 6 may be determined based on a total service quantity or a total interface quantity.

A packet processing procedure of the ToR switch is as follows.

Step 1: Receive a data stream through a SerDes.

Step 2: A multi-function interface MIFM module 1 implements processing such as decoding, error correction, framing, error check, and retransmission on the data stream, generates a first packet, and sends the first packet to an ingress processing module.

Step 3: The IP module 2 performs processing such as packet parsing, table lookup, forwarding, and editing on the first packet, determines, based on a prestored routing table, a destination MIFM module 1 corresponding to the first packet, and sends the first packet and control information to a first MFS module 41 and 42.

In a possible implementation, the ingress processing module 2 is connected to a plurality of MIFM modules 1.

Step 4: After receiving the first packet and the control information, the first MFS module 41 and 42 determines a switching path, and sends the first packet and the control information to a multi-protocol conversion module corresponding to the switching path.

The first MFS module 41 and 42 works in a first protocol corresponding to the first packet.

Step 5: The multi-protocol conversion module converts the first packet based on the first protocol into a second packet based on a second protocol, and sends the second packet to a second MFS module 41 and 42.

Step 6: The second MFS module 41 and 42 switches the second packet to a corresponding destination MIFM module 1 based on the control information.

The second MFS module 41 and 42 works in the second protocol corresponding to the second packet.

Step 7: The egress processing module 3 receives the second packet from a multi-protocol switching module, performs operations such as data parsing, table lookup, encapsulation, editing, and distribution, and sends the second packet to the connected destination MIFM module.

Step 8: The destination MIFM module 1 receives the second packet, completes processing such as segmentation and encoding, and then sends the recovered data stream to the outside through the SerDes.

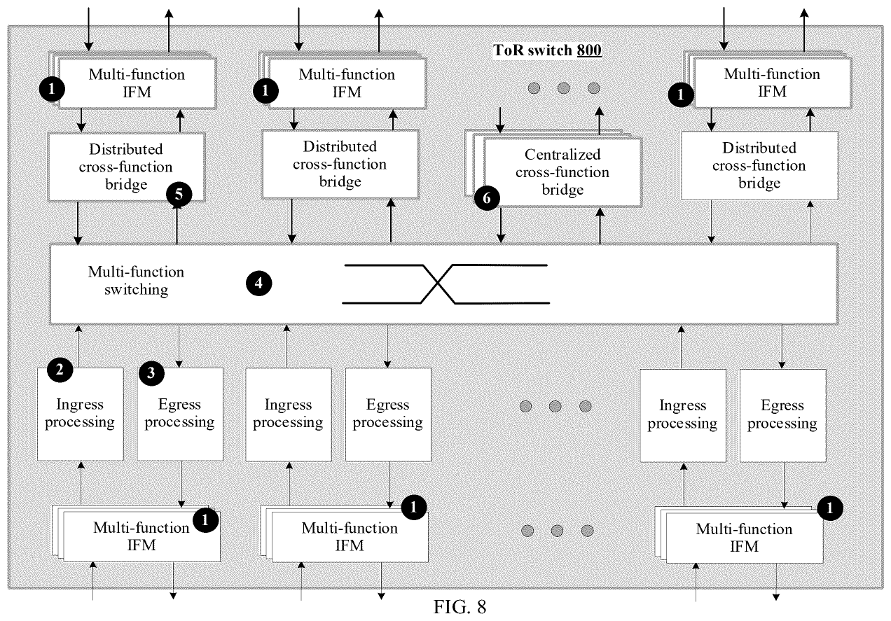

FIG. 8 provides an architecture of another ToR switch 800. In the switch architecture, functions of an IP module 2 and an EP module 3 are combined into a multi-protocol switching module 5/6. In an example, in addition to implementing inter-protocol conversion, the multi-protocol switching module 5/6needs to implement processing, including but not limited to processing such as data aggregation, parsing, table lookup, route selection, editing and forwarding, on an uplink packet. In addition, the multi-protocol switching module needs to implement processing, including but not limited to processing such as data parsing, table lookup, encapsulation, editing, and distribution, on a downlink packet. In the architecture, the MFS module 4 supports only one protocol switching. In an example, requirements on components of the MFS module can be reduced, and costs and component requirements of the switch can be reduced.

Optionally, all functions of the IP module 2 and the EP module 3 are integrated into at least one multi-protocol switching module 5/6, that is, each MIFM module 1 is connected to a corresponding MFS module 4. Alternatively, some functions of the IP module 2 and the EP module 3 are integrated into at least one multi-protocol switching module 5/6, so that some MIFM modules 1 are connected to corresponding MFS modules 4, and remaining MIFM modules 1 are respectively connected to corresponding IP modules 2 and EP modules 3. For example, the some MIFM modules may be MIFM modules connected to all servers in a cabinet.

In an implementation, the at least one multi-protocol conversion module may be a DCFB module 5, and the DCFB module 5 is disposed between two MFS modules 4 in parallel. The DCFB module 5 receives a packet from an MFS modules 4 on either side, and sends the packet to an MFS modules 4 on the other side after completing protocol conversion. A quantity of disposed DCFB module 5s may be determined based on a total service quantity or a total interface quantity.

In another implementation, the multi-protocol conversion module may alternatively be at least one CCFB module 6. When there is a plurality of CCFB modules 6, the CCFB modules 6 are disposed between the two MFS modules 4 in parallel. The CCFB module 6 receives a packet from an MFS module 4 on any side, and sends the packet back to the MFS module 4 after completing protocol conversion. A quantity of disposed CCFB modules 6 may be determined based on a total service quantity or a total interface quantity.

For example, for a ToR switch 800 in which a DCFB module 5 is configured for only an MIFM module 1 connected to a server, a packet processing procedure is as follows.

Step 1: Receive a data stream from the server through a SerDes, where the data stream is a data stream based on a first protocol, and the first protocol is one of a plurality of protocols supported by the multi-function interface module and the multi-protocol switching module 5/6 in the ToR switch 800.

Step 2: The multi-function interface MIFM module 1 implements processing such as decoding, error correction, framing, error check, and retransmission on the data stream, generates a first packet, and sends the first packet to the DCFB module 5.

Step 3: The DCFB module 5 performs processing such as packet parsing, table lookup, forwarding, and editing on the first packet, and when determining that protocol conversion is required, converts the first packet based on a first protocol into a second packet based on a second protocol, and sends the second packet and control information to an MFS module 4.

Step 4: The MFS module 4 receives the second packet and the control information, and switches the second packet to a corresponding destination MIFM module 1.

Step 5: The DCFB module 5 corresponding to the destination MIFM module 1 receives the second packet from the multi-protocol switching module 5/6, performs operations such as data parsing, table lookup, encapsulation, editing, and distribution, and sends the second packet to the connected destination MIFM module 1.

Step 6: The destination MIFM module 1 receives the second packet, completes processing such as segmentation and encoding, and then sends the recovered data stream to the outside through the SerDes.

In some embodiments, the switch may be disposed in a chassis or a cabinet of a disaggregated data center network, to internally provide a bus interface like a CXL/UB interface and interconnect all servers (for example, CPUs) and various pooled resources (accelerators, memories, storage, network interface cards, and the like) for mutual communication, and externally provide a standard Ethernet interface to connect to a spine switch, to establish a large-scale data center network.

1. A switch, comprising:
at least two interfaces configured to:
receive a to-be-forwarded packet; and
send the to-be-forwarded packet based on a first protocol or a second protocol, wherein the at least two interfaces comprise:
a first interface configured to send and receive a first packet based on the first protocol; and
a second interface configured to send and receive a second packet based on the second protocol, and wherein the to-be-forwarded packet is the first packet or the second packet;
an ingress processing apparatus configured to:
receive the to-be-forwarded packet;
obtain first indication information corresponding to the to-be-forwarded packet, wherein the first indication information indicates a destination interface in each of the at least two interfaces corresponding to the to-be-forwarded packet; and
send the first indication information; and
a switching apparatus configured to:
receive the to-be-forwarded packet and the first indication information; and
send the to-be-forwarded packet to the destination interface based on the first indication information.

2. The switch of claim 1, wherein the ingress processing apparatus is further configured to connect to the at least two interfaces.

3. The switch of claim 1, further comprising an egress processing apparatus configured to:
receive the to-be-forwarded packet and the first indication information from the switching apparatus; and
send the to-be-forwarded packet to one of the at least two interfaces, wherein one of the at least two interfaces comprises the destination interface.

4. The switch of claim 3, wherein the egress processing apparatus is configured to connect to the at least two interfaces.

5. The switch of claim 3, wherein the first indication information indicates the destination interface corresponding to the to-be-forwarded packet.

6. The switch of claim 1, wherein the first protocol and the second protocol are a Compute eXpress Link (CXL) protocol or a unified buffer (UB) protocol.

7. A switch, comprising:
at least two interfaces and configured to:
receive a to-be-forwarded packet; and
send the to-be-forwarded packet based on a first protocol or a second protocol, wherein the at least two interfaces comprise:
a first interface configured to send and receive a first packet based on the first protocol; and
a second interface configured to send and receive a second packet based on the second protocol, and wherein the to-be-forwarded packet is the first packet or the second packet;
a multi-protocol conversion apparatus configured to:
receive the to-be-forwarded packet;
convert the to-be-forwarded packet into a third packet based on a configuration, wherein the third packet and the to-be-forwarded packet are based on different protocols; and
send the third packet;
an ingress processing apparatus configured to:
receive the to-be-forwarded packet;
obtain indication information corresponding to the to-be-forwarded packet, wherein the indication information indicates a destination interface in each of the at least two interfaces corresponding to the to-be-forwarded packet; and
send the indication information; and
a first switching apparatus configured to:
receive the third packet and the indication information; and
send the third packet to a corresponding destination interface of the at least two interfaces based on the indication information.

8. The switch of claim 7, wherein the at least two interfaces are connected to the ingress processing apparatus, and wherein the ingress processing apparatus is connected to the multi-protocol conversion apparatus.

9. The switch of claim 7, wherein the interface apparatus is connected to the multi-protocol conversion apparatus, and wherein the multi-protocol conversion apparatus is connected to the ingress processing apparatus.

10. The switch of claim 7, further comprising a second switching apparatus connected to the ingress processing apparatus, wherein the interface apparatus is connected to the ingress processing apparatus and to the multi-protocol conversion apparatus.

11. The switch of claim 7, further comprising an egress processing apparatus configured to:
receive the to-be-forwarded packet and the indication information; and
send the to-be-forwarded packet to one of the interface apparatus, wherein each of the at least two interfaces comprise the destination interface.

12. The switch of claim 11, wherein the indication information indicates the destination interface corresponding to the to-be-forwarded packet.

13. The switch of claim 11, wherein the multi-protocol conversion apparatus is configured to receive the to-be-forwarded packet according to a first configuration of the ingress processing apparatus and a second configuration of the egress processing apparatus.

14. The switch of claim 7, wherein the first protocol and the second protocol are a Compute eXpress Link (CXL) protocol or a unified buffer (UB) protocol.

15. A switch cabinet, comprising:
a switch comprising:
at least two interfaces configured to:
receive a to-be-forwarded packet; and
send the to-be-forwarded packet based on a first protocol or a second protocol, wherein the at least two interfaces comprise:
a first interface configured to send and receive a first packet based on the first protocol; and
a second interface configured to send and receive a second packet based on the second protocol, and wherein the to-be-forwarded packet is the first packet or the second packet;
an ingress processing apparatus configured to:
receive the to-be-forwarded packet;
obtain first indication information corresponding to the to-be-forwarded packet, wherein the first indication information indicates a corresponding destination interface of the at least two interfaces that corresponds to the to-be-forwarded packet; and
send the first indication information;
a first switching apparatus configured to:
receive the to-be-forwarded packet and the first indication information; and
send the to-be-forwarded packet to the destination interface of the at least two interfaces based on the first indication information;
at least one server electrically connected to the switch; and
at least one resource pool electrically connected to the switch, wherein the at least one resource pool comprises at least one of a plurality of memory resources, a plurality of hard disk resources, and a plurality of accelerator resources.

16. The switch cabinet of claim 15, further comprising a multi-protocol conversion apparatus electrically connected to the switch and configured to receive the to-be-forwarded packet.

17. The switch cabinet of claim 16, wherein the multi-protocol conversion apparatus is further configured to:
convert the to-be-forwarded packet into a third packet based on a configuration, wherein the third packet and the to-be-forwarded packet are based on different protocols; and
send the third packet.

18. The switch cabinet of claim 16, further comprising an egress processing apparatus, wherein the multi-protocol conversion apparatus is configured to receive the to-be-forwarded packet according to a first configuration of the ingress processing apparatus and a second configuration of the egress processing apparatus.

19. The switch cabinet of claim 16, further comprising a second switching apparatus connected to the ingress processing apparatus, wherein the interface apparatus is connected to the ingress processing apparatus and to the multi-protocol conversion apparatus.

20. The switch cabinet of claim 15, further comprising an egress processing apparatus configured to:
receive the to-be-forwarded packet and the first indication information; and
send the to-be-forwarded packet to a corresponding destination interface of the at least two interfaces.
